(19) United States
(12) Patent Application Publication
(10) Pub. No.: US 2022/0309454 A1
(43) Pub. Date: Sep. 29, 2022

(54) Method and System for Managing Delivery

(71) Applicants: Hyundai Motor Corporation, Seoul (KR); Kia Corporation, Seoul (KR)

(72) Inventors: SiWon Kim, Seoul (KR); Bouk Goo Song, Anyang-si (KR); Wonseok Choi, Seoul (KR); Hajoon Park, Seoul (KR)

(21) Appl. No.: 17/470,197

(22) Filed: Sep. 9, 2021

(30) Foreign Application Priority Data
Mar. 24, 2021 (KR) 10-2021-0038316

(51) Int. Cl. G06Q 10/08; G06Q 10/04; G06Q 50/30

(52) U.S. Cl. CPC G06Q 10/0833; G06Q 10/047; G06Q 10/087; G06Q 50/30

(57) ABSTRACT

A delivery management method includes receiving a plurality of pieces of transaction information that includes a delivery address and delivery type information corresponding to each of the plurality of pieces of transaction information, receiving a current position of a corresponding delivery vehicle from a vehicle terminal mounted on the corresponding delivery vehicle, wherein each of a plurality of delivery vehicles including the corresponding delivery vehicle includes a respective vehicle terminal mounted thereon, allocating transaction information having an adjacent delivery address to each of the plurality of delivery vehicles, setting a basic path passing through delivery destinations in the transaction information allocated to each of the vehicle terminals for each of the plurality of delivery vehicles, and changing the basic path of a target delivery vehicle of the plurality of delivery vehicles to pass through one of the delivery destinations.

### CROSS-REFERENCE TO RELATED APPLICATIONS

This application claims the benefit of Korean Patent Application No. 10-2021-0038316, filed in the Korean Intellectual Property Office on Mar. 24, 2021, which application is hereby incorporated herein by reference.

### TECHNICAL FIELD

The present disclosure relates to a delivery management method and system.

### BACKGROUND

As online e-commerce becomes more common, importance of prompt delivery comes to the forefront. In the case of general online e-commerce, when a buyer orders a product online through online e-commerce, the ordered product is delivered to the buyer through a delivery company. On the other hand, delivery companies generally start packing the ordered product in a distribution center after receiving an order from a buyer, and then load the packaged product in a delivery vehicle to deliver it.

However, such a method has a problem that real time delivery orders are difficult because the ordered product is loaded and delivered in advance, and it takes a long time for the product to be delivered to the orderer.

The above information disclosed in this Background section is only for enhancement of understanding of the background of the invention, and therefore, it may contain information that does not form the prior art that is already known to a person of ordinary skill in the art.

### SUMMARY

Embodiments of the present disclosure can process a real-time delivery order and/or new pre-order delivery using an existing delivery vehicle when a delivery vehicle is in operation.

Embodiments of the present disclosure can enable loading and packaging of goods for real time delivery to be carried out by a delivery vehicle in operation.

Embodiments of the present disclosure can replenish inventory of a delivery vehicle without going through an item loading dock.

An embodiment of the present invention provides a delivery management method including receiving, by an integrated logistics control server, a plurality of pieces of transaction information each including a delivery address and delivery type information corresponding to each of the plurality of pieces of transaction information from an order server, receiving, by the integrated logistics control server, a current position of a corresponding delivery vehicle from a vehicle terminal mounted on each of a plurality of delivery vehicles, allocating, by the integrated logistics control server, transaction information having an adjacent delivery address to each of the plurality of delivery vehicles, setting, by the integrated logistics control server, basic path passing through a delivery destination in the transaction information allocated to each of the vehicle terminals for each of the delivery vehicles, and changing, by the integrated logistics control server, a basic path of a target delivery vehicle, which is one of the delivery vehicles, to pass through a delivery destination included in the real-time transaction information when the delivery type is a real-time delivery.

The setting of the basic path for each of the delivery vehicles may include setting, by the integrated logistics control server, the basic path as a path having a shortest movement path or a shortest movement time among a plurality of paths passing from a current position of the vehicle terminal through delivery destinations in the allocated transaction information.

A driver terminal of a driver driving the delivery vehicle may correspond to each of the plurality of delivery vehicles, and the method may further include transmitting, by the integrated logistics control server, the basic path and the plurality of pieces of transaction information allocated to the delivery vehicle to the driver terminal.

The method may further include receiving, by the integrated logistics control server, real-time transaction information related to real-time delivery from the order server when the delivery type information indicates the real-time delivery, and the real-time transaction information may include information about at least one of a type of an order item, a quantity of the order item, a real-time delivery address, and an order time.

The method may further include receiving, by the integrated logistics control server, inventory information of the delivery vehicle corresponding to the driver terminal from the driver terminal, and the inventory information may include information related to a type and a quantity of items loaded in the delivery vehicle.

The method may further include determining, by the integrated logistics control server, a target delivery vehicle for allocating the real-time transaction information, and the target delivery vehicle may be one of first delivery vehicles located within a predetermined radius from a real-time delivery address among the delivery vehicles.

The method may further include determining whether the target delivery vehicle has inventory information that satisfies the type of the order item and the quantity of the order item of the real-time transaction information.

When the target delivery vehicle satisfies the real-time transaction information, the method further includes changing, by the integrated logistics control server, a delivery path such that the target delivery vehicle passes through the real-time delivery address from the basic path of the target delivery vehicle.

When the target delivery vehicle cannot satisfy the real-time transaction information, the method may further include determining, by the integrated logistics control server, a supplementary vehicle for replenishing insufficient inventory of the target delivery vehicle, and the supplementary vehicle may be at least one of the delivery vehicles, and may have inventory information that is integrated with the inventory information of the target delivery vehicle to satisfy the real-time transaction information.

The method may further include generating, by the integrated logistics control server, supplementary information including the type and quantity of items that the target delivery vehicle should receive from the supplementary vehicle, and transmitting, by the integrated logistics control server, the real-time transaction information and the supplementary information to a driver terminal of the target delivery vehicle and a driver terminal of the supplementary vehicle.

The method may further include changing, by the integrated logistics control server, delivery paths of the target delivery vehicle and the supplementary vehicle such that the target delivery vehicle and the supplementary vehicle meet at an intermediate point between the basic path of the target delivery vehicle and the basic path of the supplementary vehicle, and transmitting, by the integrated logistics control server, the changed delivery paths to the driver terminal of the target delivery vehicle and the driver terminal of the supplementary vehicle.

An embodiment of the present invention provides a delivery management system including an order server configured to transmit a plurality of pieces of transaction information each including a delivery address and delivery type information corresponding to each of the plurality of pieces of transaction information to an integrated logistics control server, and the integrated logistics control server configured to receive a current position of a corresponding delivery vehicle from a vehicle terminal mounted on each of a plurality of delivery vehicles, to allocate transaction information having an adjacent delivery address to each of the delivery vehicles, to set a basic path passing through delivery destinations in the transaction information allocated to each of the vehicle terminals for each of the delivery vehicles, and to change a basic path of a target delivery vehicle, which is one of the delivery vehicles, to pass through a delivery destination included in the real-time transaction information when a delivery type is real-time delivery.

The basic path may be a path having a shortest movement path or a shortest movement time among a plurality of paths passing from a current position vehicle terminal through delivery destinations in the assigned transaction information.

A driver terminal of a driver driving the delivery vehicle may correspond to each of the delivery vehicles, and the integrated logistics control server may transmit the plurality of pieces of transaction information allocated to the delivery vehicle and the basic path to the driver terminal.

The integrated logistics control server may receive real-time transaction information related to real-time delivery from the order server when the delivery type information indicates the real-time delivery, and the real-time transaction information may include information about at least one of a type of an order item, a quantity of the order item, a real-time delivery address, and an order time.

The integrated logistics control server may further receive inventory information of the delivery vehicle corresponding to the driver terminal from the driver terminal, and the inventory information may include information related to a type and a quantity of items loaded in the delivery vehicle.

The integrated logistics control server may determine a target delivery vehicle for allocating the real-time transaction information, and the target delivery vehicle may be one of first delivery vehicles located within a predetermined radius from an address of the real-time delivery among the delivery vehicles.

The integrated logistics control server may determine the target delivery vehicle by determining whether the target delivery vehicle has inventory information that satisfies the type of the order item and the quantity of the order item of the real-time transaction information.

When the target delivery vehicle satisfies the real-time transaction information, the method may further include changing, by the integrated logistics control server, a delivery path such that the target delivery vehicle passes through the real-time delivery address from the basic path of the target delivery vehicle.

When the target delivery vehicle cannot satisfy the real-time transaction information, the integrated logistics control server may determine a supplementary vehicle for replenishing insufficient inventory of the target delivery vehicle, and the supplementary vehicle may be at least one of the delivery vehicles, and may have inventory information that is integrated with the inventory information of the target delivery vehicle to satisfy the real-time transaction information.

The integrated logistics control server may generate supplementary information including the type and quantity of items that the target delivery vehicle should receive from the supplementary vehicle, and transmit the real-time transaction information and the supplementary information to a driver terminal of the target delivery vehicle and a driver terminal of the supplementary vehicle.

The integrated logistics control server may change delivery paths of the target delivery vehicle and the supplementary vehicle such that the target delivery vehicle and the supplementary vehicle meet at an intermediate point between basic paths of the target delivery vehicle and the supplementary vehicle, and transmit the changed delivery paths to the driver terminal of the target delivery vehicle and the driver terminal of the supplementary vehicle.

An embodiment of the present invention provides a logistics control server including an order server configured to receive a plurality of pieces of transaction information each including a delivery address and delivery type information corresponding to each of the plurality of pieces of transaction information from a user terminal, and a vehicle control server configured to assign a driver to each of a plurality of delivery vehicles, and the integrated logistics control server may be configured to receive a current position of a corresponding delivery vehicle from a vehicle terminal mounted on each of a plurality of delivery vehicles, to allocate transaction information having an adjacent delivery address to each of the delivery vehicles, to set a basic path passing through delivery destinations in the transaction information allocated to each of the vehicle terminals for each of the delivery vehicles, and to change a basic path of a target delivery vehicle, which is one of the delivery vehicles, to pass through a delivery destination included in the real-time transaction information when a delivery type is real-time delivery.

An embodiment of the present invention provides a logistics control server including a vehicle control server configured to assign a driver to each of a plurality of delivery vehicles, and the integrated logistics control server may be configured to receive a plurality of pieces of transaction information each including a delivery address and delivery type information corresponding to each of the plurality of pieces of transaction information from a user terminal, to receive a current position of a corresponding delivery vehicle from a vehicle terminal mounted on each of a plurality of delivery vehicles, to allocate transaction information having an adjacent delivery address to each of the delivery vehicles, to set a basic path passing through delivery destinations in the transaction information allocated to each of the vehicle terminals for each of the delivery vehicles, and to change a basic path of a target delivery vehicle, which is one of the delivery vehicles, to pass through a delivery destination included in the real-time transaction information when a delivery type is real-time delivery.

An embodiment of the present invention provides a delivery management system including an order server configured to transmit a plurality of pieces of transaction information each including a delivery address and delivery type information corresponding to each of the plurality of pieces of transaction information to an integrated logistics control server, and the integrated logistics control server configured to receive a current position of a corresponding delivery vehicle from a vehicle terminal mounted on each of a plurality of delivery vehicles, to allocate transaction information having an adjacent delivery address to each of the delivery vehicles, to set a basic path passing through delivery destinations in the transaction information allocated to each of the vehicle terminals for each of the delivery vehicles, to determine a target delivery vehicle for allocating real-time transaction information when a delivery type is real-time delivery, and to change the basic path of the target delivery vehicle to pass through a delivery destination included in the real-time transaction information, wherein the delivery vehicle is a delivery vehicle having a shortest movement distance from a last delivery destination to a real-time delivery destination among the delivery vehicles when a completion time for a delivery corresponding to the real-time transaction information is within a predetermined time from an acceptance time for the real-time delivery in the case where the integrated logistics control server calculates a completion time for a delivery corresponding to transaction information assigned to each of the vehicle terminals by calculating a time it takes to travel to the last delivery destination among basic paths that are set for each of the vehicle terminals, and calculates the completion time for the delivery corresponding to the real-time transaction information by calculating the distance from the last delivery destination to the real-time delivery destination in the real-time transaction information for each of the delivery vehicles.

The program according to an embodiment may be stored in a recording medium to perform a delivery control method.

A recording medium according to an embodiment may store a program that performs a delivery management method.

In addition, according to at least one of the embodiments of the present disclosure, a purchaser may receive an ordered item at a desired time.

In addition, according to at least one of the embodiments of the present disclosure, a time that is spent on delivery may be reduced.

In addition, according to at least one of the embodiments of the present disclosure, delivery efficiency may be improved.

### BRIEF DESCRIPTION OF THE DRAWINGS

FIG. 1 schematically illustrates a delivery management system.

FIG. 2 illustrates a diagram schematically showing an update status of inventory information of a delivery management system according to an embodiment.

FIG. 3 illustrates a flowchart showing a method of pre-order delivery according to an embodiment.

FIG. 4 illustrates a flowchart showing a delivery method of a real-time delivery order according to an embodiment.

### DETAILED DESCRIPTION OF ILLUSTRATIVE EMBODIMENTS

Hereinafter, embodiments disclosed in the present specification will be described in detail with reference to the accompanying drawings. In the present specification, the same or similar components will be denoted by the same or similar reference numerals, and a repeated description thereof will be omitted. Terms “module” and/or “unit” for components used in the following description are used only in order to easily describe the specification. Therefore, these terms do not have meanings or roles that distinguish them from each other in and of themselves. In describing embodiments of the present specification, when it is determined that a detailed description of the well-known art associated with the present invention may obscure the gist of the present invention, it will be omitted. The accompanying drawings are provided only in order to allow embodiments disclosed in the present specification to be easily understood and are not to be interpreted as limiting the spirit disclosed in the present specification, and it is to be understood that the present invention includes all modifications, equivalents, and substitutions without departing from the scope and spirit of the present invention.

Terms including ordinal numbers such as first, second, and the like will be used only to describe various components, and are not to be interpreted as limiting these components. The terms are only used to differentiate one component from other components.

It will be further understood that terms “comprises/includes” or “have” used in the present specification specify the presence of stated features, numerals, steps, operations, components, parts, or a combination thereof, but do not preclude the presence or addition of one or more other features, numerals, steps, operations, components, parts, or a combination thereof.

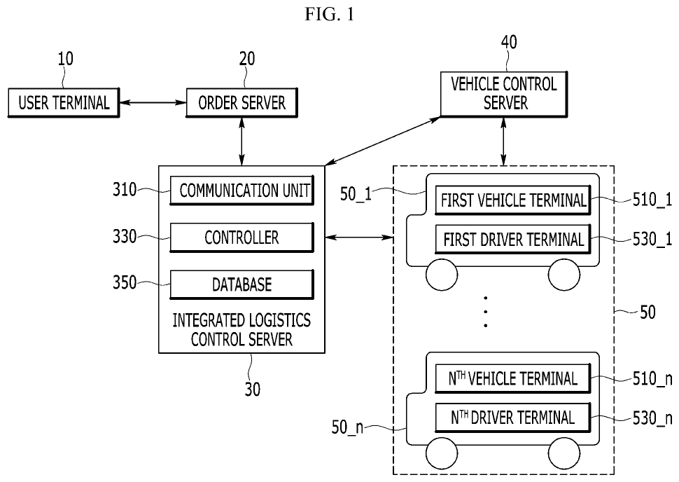

FIG. 1 schematically illustrates a delivery management system 1.

The delivery management system 1 includes a user terminal 10, an order server 20, an integrated logistics control server 30, a vehicle control server 40, a plurality of delivery vehicles 50_1 to 50_n, a plurality of vehicle terminals 510_1 to 510_n, and a plurality of driver terminals 530_1 to 530_n. In FIG. 1, one user terminal 10 is illustrated, but this is for convenience of description, and the present invention is not limited thereto.

The user terminal 10, the order server 20, the integrated logistics control server 30, the vehicle control server 40, the delivery vehicles 50_1 to 50_n, the vehicle terminals 510_1 to 510_n, and the driver terminals 530_1 to 530_n may be connected to each other through a network to transmit and receive information necessary for ordering and delivery of products.

The network may be implemented as any type of wired or wireless network such as a local area network (LAN), a wide area network (WAN), a value added network (VAN), a personal area network (PAN), a mobile radio communication network, wireless broadband internet (WiBro), a mobile WiMAX, a high speed downlink packet access (HSDPA), or a satellite communication network, but the present invention is not limited thereto.

A user may order a product to the order server 20 through the user terminal 10. The user terminal 10 may be a wireless communication device in which portability and mobility are guaranteed.

For example, the user terminal 10 may be any type of portable wireless communication device such as a personal communication system (PCS), a global system for mobile communications (GSM), a personal digital cellular (PDC), a personal handyphone system (PHS), a personal digital assistant (PDA), an international mobile telecommunication, code division multiple access (CDMA), W-code division multiple access (W-CDMA), and wireless broadband internet (WiBro) terminals. In particular, the user terminal 10 may be a smart phone that can install and run a number of application programs (i.e., applications) desired by a user, and may be a PC that can be connected to the order server 20 through wired or wireless communication.

Specifically, the user terminal 10 may access the order server 20 through a network to generate transaction information for an item to be ordered, and may transmit it to the order server 20. The transaction information may include order information and user information.

The order information may include information related to a type of the item to be ordered, a quantity of the item, a delivery address, and an order time at which the order is received. The user information may include information related to a user name and user contact information.

The user may select delivery type information together while generating transaction information through the user terminal 10. The delivery type may be one of general delivery, real-time delivery, and reservation delivery.

When the delivery type is the reservation delivery, the delivery type information may include information related to a reservation date and a reservation time at which the user wants to receive the item.

For example, when the user selects the reservation delivery, the user may transmit the reservation date and the reservation time for receiving the item to the order server 20 through the user terminal 10.

When the delivery type is real-time delivery, a real-time delivery request may be transmitted to the order server 20 through the user terminal 10. As described in detail below, the order server 20 receiving the real-time delivery request may transmit a real-time delivery request to the integrated logistics control server 30, and the integrated logistics control server 30 may change a delivery path of the delivery vehicles 50_1 to 50_n such that delivery is completed within a predetermined time in consideration of a current position and a delivery path of each of the delivery vehicles 50_1 to 50_n.

The user may input a payment method to the order server 20 through the user terminal 10. Thereafter, the order server 20 may proceed with payment for the ordered item using the user payment method that is inputted through the user terminal 10, and may determine that the order has been completed when the payment is completed.

Thereafter, when the order is completed, the user terminal 10 may receive a current position of the purchased item, an expected arrival time, and delivery status information from the integrated logistics control server 30. The user may check the current position, the expected arrival time, and the delivery status information of the purchased item through the user terminal 10.

The order server 20 may integrate transaction information and delivery type information received from a plurality of user terminals 10 and transmit it to the integrated logistics control server 30, and may transmit the information received from the integrated logistics control server 30 to the user terminal 10.

Specifically, the order server 20 may receive the transaction information and the delivery type information from the user terminal 10. Thereafter, the order server 20 may integrate the received transaction information and the delivery type information corresponding thereto and transmit it to the integrated logistics control server 30, and may proceed with payment for the item upon receiving information that the ordered item can be delivered at a requested time from the integrated logistics control server 30.

The order server 20 may acquire a payment method from the user terminal 10 to store it. The payment method may be set in advance through the user terminal 10 before payment. For example, when signing up for a delivery service or placing an order for the first time, a user inputs payment information through the user terminal 10, and the order server 20 may receive the corresponding information from the user terminal 10 to store it. The user may update the payment information through the user terminal 10. The order server 20 may process payment for an ordered item according to preset payment information or the updated payment information.

When receiving information that delivery is not possible from the integrated logistics control server 30, the order server 20 may transmit an alarm to the user terminal 10 that the ordered item cannot be delivered in accordance with the requested time. In addition, the order server 20 may transmit a proposal to allow the user to set a different delivery type and/or a different reservation time together with a delivery impossibility alarm.

The order server 20 may determine that the order is complete when payment for the ordered item is completed, and may transmit order confirmation information to the user terminal 10.

The vehicle control server 40, which is a server that manages information related to the delivery vehicles 50_1 to 50_n, may store information related to the delivery vehicles 50_1 to 50_n.

The vehicle information may include information related to the delivery vehicles 50_1 to 50_n collected from the vehicle terminals 510_1 to 510_n provided in the delivery vehicles 50_1 to 50n, e.g., fleet management system (FMS) data and position information for the delivery vehicles 50_1 to 50n. In addition, the vehicle information includes information related to a plurality of drivers assigned to the delivery vehicles 50_1 to 50_n, information related to a plurality of driver terminals 530_1 to 530_n of the drivers, and information related to the driver terminals 530_1 to 530_n corresponding to the vehicle terminals 510_1 to 510_n.

The vehicle control server 40 may generate driver assignment information by assigning a driver to each of the delivery vehicles 50_1 to 50_n. The driver may load items directly into the assigned delivery vehicle, or may be assigned a delivery vehicle with items loaded in advance. In this case, the vehicle control server 40 may allocate a driver to each of the delivery vehicles 50_1 to 50n, and at the same time, may allow a vehicle terminal 510_i mounted on a delivery vehicle 50_i (i is one of natural numbers from 1 to n) to correspond to the driver terminal 530_i. Herein, it has been described that the vehicle control server 40 generates the driver assignment information, but the invention is not limited thereto. For example, as will be described later, the integrated logistics control server 30 may generate the driver assignment information.

The vehicle control server 40 may transmit vehicle information to the integrated logistics control server 30.

As described later, position information of each of the delivery vehicles 50_1 to 50_n may be transmitted to the vehicle control server 40 through the vehicle terminals 510_1 to 510_n. Thereafter, the position information of each of the delivery vehicles 50_1 to 50_n may not only be transmitted from the vehicle control server 40 to the integrated logistics control server 30, but may also directly transmit driver information to each of the plurality of delivery vehicles 50_1 to 50_n to the integrated logistics control server 30 from each of the vehicle terminals 510_1 to 510_n without going through the vehicle control server 40.

Each of the delivery vehicles 50_1 to 50_n, which are vehicles that load ordered items and perform delivery, operates along a delivery path through at least one delivery destination.

Initially, the delivery vehicles 50_1 to 50_n may be positioned in an item loading dock. The item loading dock is a place where delivery goods delivered from sellers are collected.

As illustrated in FIG. 1, the vehicle terminals 510_1, . . . , and 510_n and the driver terminals 530_1, . . . , and 530_n are provided in the delivery vehicles 50_1, . . . , and 50_n.

That is, the vehicle terminal 510_i may be mounted on the delivery vehicle 50_i operated by the driver having the driver terminal 530_i (i is one of natural numbers from 1 to n). The vehicle information may include driver assignment information, which is information related to a correspondence relationship between the driver terminal 530_i and the vehicle terminal 510_i mounted on the delivery vehicle 50_i.

The vehicle terminal 510_i is a terminal mounted on the delivery vehicle 50_i to transmit position information and/or vehicle information of the vehicle to the vehicle control server 40 and/or the integrated logistics control server 30. For example, the vehicle terminal 510_i may be a global positioning system (GPS) terminal.

The vehicle terminal 510_i may transmit position information of the delivery vehicle 50_i to the vehicle control server 40 and/or the integrated logistics control server 30 in real time or in a predetermined time unit. The vehicle information may be information related to information such as a number of items that the delivery vehicle 50_i can accommodate, a volume of the items, and a total weight of the items, and/or a status such as a remaining battery capacity, a travel distance, a tire pressure, an operating time, etc. of a vehicle.

The driver terminal 530_i is a personal terminal capable of wired or wireless communication of a driver driving the delivery vehicle 50_i.

The driver terminal 530_i may be a wireless communication device in which portability and mobility are guaranteed. An application for requesting an order to the order server 20 may be installed in the driver terminal 530_i.

The driver may receive transaction information allocated to the delivery vehicle 50_i that is in charge of corresponding delivery, information related to an optimal delivery path, and the like from the integrated logistics control server 30 through the driver terminal 530_i.

The driver may transmit inventory information related to items loaded in the delivery vehicle 50_i to the integrated logistics control server 30 through the driver terminal 530_i. For example, the driver may directly load the items into the assigned delivery vehicle 50_i, and may transmit inventory information to the integrated logistics control server 30. Alternatively, the driver may be assigned to the delivery vehicle 50_i in which the items are loaded in advance, may check the inventory of the items, and may transmit inventory information to the integrated logistics control server 30.

The driver may transmit delivery status information to the integrated logistics control server 30 through the driver terminal 530_i. The delivery status information may be one of preparing for delivery, starting delivery, performing delivery, and completing delivery.

The driver may transmit working status information of the driver to the integrated logistics control server 30 through the driver terminal 530_i. The working status information may be a rest status, an order assignment available status, and the like. When the driver transmits information related to the rest status to the integrated logistics control server 30 through the driver terminal 530_i, the integrated logistics control server 30 does not consider the delivery vehicle 50_i in allocating transaction information.

In addition, the driver terminal 530_i may transmit position information of the driver terminal 530_i to the integrated logistics control server 30 in real time or in a predetermined time unit. In general, a position of the vehicle terminal 510_i and a position of the driver terminal 530_i may be the same. However, when the driver moves away from the delivery vehicle, such as when delivering the delivery items to a user, the position of the vehicle terminal 510_i and the position of the driver terminal 530_i may be different.

Herein, although it has been described that the data collected from the driver terminal 530_i, i.e., inventory information for items, delivery status information, working status information of a driver, and position information of the driver terminal 530_i may be transmitted from the driver terminal 530_i to the integrated logistics control server 30, the data may be transmitted from the driver terminal 530_i to the integrated logistics control server 30 via the vehicle control server 40.

The integrated logistics control server 30 may receive information from the order server 20 and the vehicle control server 40, and may allocate transaction information to each of the vehicle terminals 510_1, . . . , and 510_n, and may derive a delivery path of each delivery vehicle.

The integrated logistics control server 30 may generate driver assignment information by assigning a driver to each of the delivery vehicles 50_1 to 50_n instead of the vehicle control server 40. In this case, the integrated logistics control server 30 may allocate a driver to each of the delivery vehicles 50_1 to 50_n, and at the same time, may allow a vehicle terminal 510_i mounted on a delivery vehicle 50_i to correspond to the driver terminal 530_i, instead of the vehicle control server 40. The integrated logistics control server 30 includes a communication unit 310, a controller 330, and a database 350.

The communication unit 310 is for communicating with the order server 20, the vehicle control server 40, the driver terminals 530_1 to 530_n, and the vehicle terminals 510_1 to 510_n through a network. The communication unit 310 may transmit data received from the order server 20, the vehicle control server 40, the driver terminals 530_1 to 530_n, and the vehicle terminals 510_1 to 510_n to the controller 330, or may transmit data received from the controller 330 to the order server 20, the vehicle control server 40, the delivery vehicles 50_1 to 50_n, the driver terminals 530_1 to 530_n, and the vehicle terminals 510_1 to 510_n through a network.

The controller 330 is for processing data received through the communication unit 310 and data stored in the database 350 to generate information necessary for reservation delivery and real-time delivery service. The controller 330 may be implemented as software or a program including a combination of software that performs a function necessary to provide a reservation delivery and a real-time delivery service, and the program may be stored in a storage medium of the integrated logistics control server 30. The storage medium may be implemented with various types of memory including a non-volatile memory such as a high-speed random access memory (a magnetic disk storage device, a flash memory device, and other non-volatile solid-state memory devices).

The database 350 may store information set in advance for a reservation delivery and a real-time delivery service, and may store necessary information from among the information acquired through the communication unit 310 or generated by the controller 330.

Hereinafter, for convenience of explanation, it will be described that the entity performing each step is the integrated logistics control server 30.

The integrated logistics control server 30 may receive transaction information and delivery type information from the order server 20, may receive vehicle information from the vehicle control server 40, and may allocate transaction information to each of the delivery vehicles 50_1 to 50_n based on the received information. For example, the integrated logistics control server 30 may consider vehicle information such as a remaining battery capacity, a current position, and a path of each of the delivery vehicles 50_1 to 50_n. In addition, the integrated logistics control server 30 may consider driver information including a working state of a driver, such as a rest state of the driver and an order assignment possible state, and may allocate order information to each of the delivery vehicles 50_1 to 50_n in consideration of a current traffic condition and inventory information.

When the delivery type information received by the integrated logistics control server 30 is a general delivery and/or a reservation delivery, the integrated logistics control server 30 may allocate transaction information to each of the delivery vehicles 50_1 to 50_n in consideration of position information of each of the delivery vehicles 50_1 to 50_n and positions of delivery destinations. For example, the integrated logistics control server 30 may allocate transaction information to the delivery vehicle 50_i positioned closest to adjacent delivery destinations by integrating transaction information adjacent to the delivery destination.

When receiving a real-time delivery order, the integrated logistics control server 30 may determine a delivery vehicle to which a real-time delivery order is to be allocated based on an order time, position information of each of the vehicle terminals 510_1 to 510_n, and inventory information of each of the delivery vehicles 50_1 to 50_n. In this case, each of the delivery vehicles 50_1 to 50_n may be in the middle of performing delivery along a basic delivery path preset by the integrated logistics control server 30.

In embodiments of the present disclosure, the integrated logistics control server 30, the order server 20, and the vehicle control server 40 are described as being separate configurations, but the order server 20 and/or the vehicle control server 40 may be included in the integrated logistics control server 30.

For example, when the integrated logistics control server 30 includes the order server 20, the integrated logistics control server 30 may simultaneously perform the role of the order server 20 described above.

The integrated logistics control server 30 may receive transaction information and delivery type information from the user terminal 10. Specifically, when the delivery type is a reservation delivery, the integrated logistics control server 30 may receive a reservation date and a reservation time for receiving an item through the user terminal 10. In addition, the integrated logistics control server 30 may receive a real-time delivery request through the user terminal 10 when the delivery type is a real-time delivery.

The integrated logistics control server 30 may integrate transaction information and delivery type information received from the user terminal 10, and may transmit information received from the vehicle control server 40 to the user terminal 10.

A user may input a payment method to the integrated logistics control server 30 through the user terminal 10. The integrated logistics control server 30 may proceed with payment for an ordered item upon receiving information that the ordered product is available for delivery at a requested time and/or information that a real-time delivery is possible.

As another example, when the integrated logistics control server 30 includes the order server 20 and the vehicle control server 40, the integrated logistics control server 30 may perform roles of the order server 20 and the vehicle control server 40 together.

In this case, the integrated logistics control server 30 may perform the role of the vehicle control server 40 in addition to performing the role of the order server 20 as described above. The integrated logistics control server 30 may generate driver assignment information by assigning a driver to each of the delivery vehicles 50_1 to 50_n. In addition, vehicle information required to manage the delivery vehicles 50_1 to 50_n may be stored in the integrated logistics control server 30.

Hereinafter, a delivery vehicle to which a real-time delivery order is assigned among the delivery vehicles 50_1 to 50_n is referred to as a target delivery vehicle 50_m, where m is one of natural numbers from 1 to n.

The integrated logistics control server 30 may check an order time in order information when the real-time delivery order is received. Thereafter, the integrated logistics control server 30 checks a position of a real-time delivery destination included in the order information, and checks position information of a plurality of vehicle terminals (e.g., 510_j, . . . , and 510_k, where j and k are each one of natural numbers from 1 to n) positioned in a predetermined radius around the delivery destination among the vehicle terminals 510_1 to 510_n. Thereafter, the integrated logistics control server 30 may derive a plurality of delivery vehicles (e.g., 50_p, . . . , and 50_q, where p and q are each one of natural numbers from 1 to n) capable of performing delivery within a predetermined time from the order time, in consideration of a movement path and traffic conditions from a current position of each of the vehicle terminals 510_j, . . . , and 510_k.

Thereafter, the integrated logistics control server 30 may allocate real-time delivery orders to a plurality of delivery vehicles positioned at a closest distance from the delivery destination or on a delivery vehicle with a shortest travel time based on the position information of the vehicle terminals 510_p, . . . , and 510_q among the delivery vehicles 50_p, . . . , and 50_q. That is, the integrated logistics control server 30 may allocate the real time delivery orders in consideration of a current position and the delivery destination position of each of the vehicle terminals 510_p, . . . , and 510_q.

When determining the target delivery vehicle 50_m to which the real-time delivery order is to be assigned, the integrated logistics control server 30 may consider traffic condition information related to a movement path between a current position and a delivery destination of each of the vehicle terminals 510p, . . . , and 510_q. A specific method for determining the target delivery vehicle 50_m for the integrated logistics control server 30 to allocate the real time delivery order will be described later.

Furthermore, the integrated logistics control server 30 may also determine the target delivery vehicle 50_m to which the real time delivery order is to be allocated in consideration of inventory information of each of the delivery vehicles 50_p, . . . , and 50_q. When there is no delivery vehicle having inventory information that satisfies the transaction information of the real-time delivery order among the vehicle terminals 510_p, . . . , and 510_q, the integrated logistics control server 30 may determine a supplementary vehicle for replenishing the insufficient inventory of the target delivery vehicle together with the target delivery vehicle.

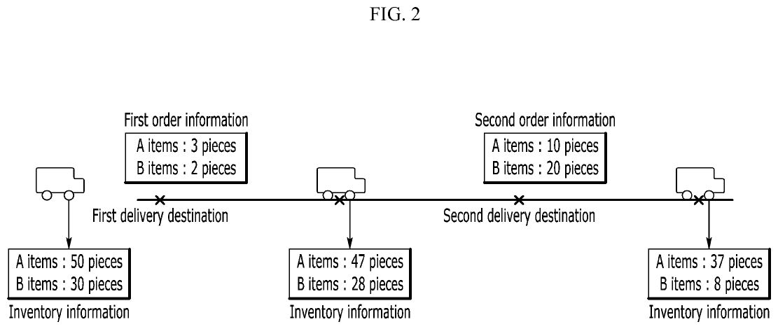

Specifically, the integrated logistics control server 30 may acquire inventory information of each of the delivery vehicles 50_1 to 50_n from the driver terminals 530_1 to 530_n. In this case, each of the delivery vehicles 50_1 to 50_n may be performing delivery along an optimal delivery path predetermined by the integrated logistics control server 30. As each of the delivery vehicles 50_1 to 50_n performs delivery, the integrated logistics control server 30 may update inventory information for each of the delivery vehicles 50_1 to Son. For example, the integrated logistics control server 30 may update inventory information whenever delivery status information of the driver terminals 530_1 to 530_n changes. This will be described later with reference to FIG. 2.

After allocating transaction information to each of the delivery vehicles 50_1 to 50_n, the integrated logistics control server 30 may set an optimal delivery path for each of the delivery vehicles 50_1 to 50_n. The integrated logistics control server 30 may set an optimal delivery path for each of the delivery vehicles 50_1 to 50_n based on delivery address information included in order information assigned to each of the delivery vehicles 50_1 to 50_n. The optimal delivery route may be set as a path having a shortest movement path or a path having a shortest movement time among multiple paths that can move from a current position of each of the delivery vehicles 50_1 to 50_n to an assigned delivery destination.

The integrated logistics control server 30 may set an optimal delivery path for each of the delivery vehicles 50_1 to 50_n based on order information received in advance from the order server 20, such as regular delivery and/or reservation delivery. In the case of the reservation delivery, the integrated logistics control server 30 may set an optimal delivery path in consideration of a reservation time.

In addition, the integrated logistics control server 30 may set an optimal delivery path for each of the delivery vehicles 50_1 to 50_n based on position information received from the vehicle terminals 510_1 to 510_n and current traffic conditions and/or road information received from a traffic information providing server. Herein, traffic situation information may include traffic congestion information, vehicle accident information, and the like. The road information may include lane information, speed limit information, and the like of a road in each area.

In the present specification, the optimal delivery path set by the integrated logistics control server 30 based on the order information received in advance is referred to as a basic path.

The integrated logistics control server 30 may set an optimal delivery path by using an artificial neural network in which road information is learned in advance.

The integrated logistics control server 30 may predict the movement time of each of the delivery vehicles 50_1 to 50_n based on a movement distance between a current position and a delivery destination of each of the vehicle terminals 510_1 to 510_n, and traffic situation information. Accordingly, it is possible to predict a time that a delivery vehicle passes each position of the delivery path. That is, the integrated logistics control server 30 may calculate an estimated arrival time.

The integrated logistics control server 30 may change the basic route of each of the delivery vehicles 50_1 to 50_n based on the real-time delivery order received from the order server 20 thereafter. That is, the integrated logistics control server 30 may set a basic delivery path based on the order information received in advance, and change the set basic path depending on the real-time delivery order received thereafter.

When the real-time delivery order is received, the integrated logistics control server 30 may allocate real-time delivery order information by selecting a vehicle having a minimum movement time or a shortest movement distance to the delivery destination among the delivery vehicles 50_1 to 50_n.

Specifically, the integrated logistics control server 30 may determine the target delivery vehicle 50_m to which order information of the real-time delivery order is to be allocated based on the current position of each of the delivery vehicles 50_1 to 50_n, traffic conditions, an order time, a basic path, a movement distance, a real-time delivery order completion time, customer satisfaction of a delivery vehicle driver, inventory information, etc. Thereafter, the integrated logistics control server 30 may change the delivery path of the target delivery vehicle 50_m to pass through the delivery destination in the order information of the real-time delivery order.

The integrated logistics control server 30 may calculate a time taken to complete deliveries corresponding to order information to which the delivery vehicles 50_1 to 50_n are allocated in consideration of the delivery information, position information, traffic condition information, and/or road information of each of the delivery vehicles 50_1 to 50_n. Thereafter, the integrated logistics control server 30 may predict a time when currently allocated deliveries for all of the delivery vehicles 50_1 to 50_n are completed. Then, the integrated logistics control server 30 may calculate a distance from a last delivery address corresponding to last order information among the order information allocated to each of the delivery vehicles 50_1 to 50_n to a real-time delivery address of a received real-time delivery order, and may then predict a time when real-time delivery is completed. In this case, the integrated logistics control server 30 determines whether the time at which the real-time delivery is completed is within a predetermined time from the time the real-time delivery order is received, and when it is within the predetermined time, determines the delivery vehicle with the shortest movement distance as the target delivery vehicle 50_m.

In the case of a delivery vehicle currently performing delivery (50_d, . . . , and 50_e, where d and e are one of natural numbers from 1 to n), the integrated logistics control server 30 may predict a time when all deliveries of the transaction information allocated to each of the delivery vehicles 50_d, . . . , and 50_e are completed. In this case, the integrated logistics control server 30 may consider a time it takes for the delivery vehicles 50_d, . . . , and 50_e to park at each destination, a time it takes to pick and pack delivered items, and a time it takes to deliver the items.

Thereafter, the integrated logistics control server 30 may calculate a distance from a last delivery destination of each of the delivery vehicles 50_d, . . . , and 50_e to a real-time delivery destination of the received real-time delivery order in a sequence of the vehicles with an earliest delivery completion time among the delivery vehicles 50_d, . . . , and 50_e.

Accordingly, the integrated logistics control server 30 may calculate a time it takes for each delivery vehicle 50_d, . . . , and 50_e to reach the real-time delivery destination in consideration of position information, traffic information, and/or road information. The integrated logistics control server 30 may derive an expected time at which real-time delivery is completed for each of the delivery vehicles 50_d, . . . , and 50_e.

For example, the integrated logistics control server 30 may set an optimal delivery path for each of the delivery vehicles 50_d, . . . , and 50_e to a real-time delivery destination based on information related to current traffic conditions and/or road information received from a traffic information providing server, and may calculate the travel time of each of the delivery vehicles 50_d, . . . , and 50_e based on a movement distance between a current position of each of the delivery vehicles 50_d, . . . , and 50_e and a delivery destination, and traffic situation information.

In the case of a delivery vehicle that is not currently performing delivery (50_j, . . . , and 50_k, where j and k are each one of natural numbers from 1 to n), the integrated logistics control server 30 may calculate a distance from each position of the current delivery vehicles 50_j, . . . , and 50_k to a real-time delivery destination.

Accordingly, the integrated logistics control server 30 may calculate a time it takes for each delivery vehicle 50_j, . . . , and 50_k to reach the real-time delivery destination in consideration of position information, traffic information, and/or road information. The integrated logistics control server 30 may derive an expected time at which real-time delivery is completed for each of the delivery vehicles 502j, . . . , and 50_k.

The integrated logistics control server 30 may derive delivery vehicles having an estimated time at which real-time delivery is completed is within a predetermined time from a time when the real-time delivery order is received from among the delivery vehicles 50_d, . . . , and 50_e performing delivery and/or delivery vehicles 50_j, . . . , and 50_k not performing delivery. Delivery vehicles in which an estimated time at which real-time delivery is completed is within a predetermined time from the time the real-time delivery order is received are referred to as delivery vehicles (50_t, . . . , and 50_u, wherein t and u are each one of natural numbers from 1 to n).

The integrated logistics control server 30 may determine a delivery vehicle having a shortest movement distance as the target delivery vehicle 50_m, in a distance from a last delivery destination of the delivery vehicle 50_d, . . . , and 50_e to the real-time delivery destination and/or a distance from a position of the current delivery vehicle 50_j, . . . , and 50_k to a real-time delivery destination among the delivery vehicles 50_t, . . . , and 50_u.

That is, the integrated logistics control server 30 may allocate the real-time delivery order to the delivery vehicle having the shortest movement distance on the assumption that the real-time delivery is completed within a predetermined time.

When no delivery vehicle among the delivery vehicles 50_1 to 50_n completes delivery within the predetermined time from the time the real-time delivery order is received, the integrated logistics control server 30 may determine a delivery vehicle having an earliest time when the real-time delivery is completed as the target delivery vehicle 50_m.

In addition, the integrated logistics control server 30 may sequentially check whether inventory information of the delivery vehicles 50_h, 50_g, 50_f, . . . may satisfy the order information in the real-time delivery order depending on the corresponding order, and may determine a delivery vehicle that satisfies the order information as the target delivery vehicle 50_m.

When there is no delivery vehicle having inventory information that satisfies the order information in the real-time delivery order among the delivery vehicles 50_h, 50_g, 50_f, . . . , the integrated logistics control server 30 may determine the target delivery vehicle 50_m and a supplementary vehicle 50_s, (s is one of natural numbers from 1 to n) for replenishing inventory of the target delivery vehicle 50_m among the delivery vehicles 50_h, 50_g, 50_f, . . . . The supplementary vehicle is a vehicle that has inventory included in the order information in the real-time delivery order. In the present specification, for convenience of description, it is described that there is only one supplementary vehicle, but the present invention is not limited thereto.

After determining the target delivery vehicle 50_m and the supplementary vehicle 50_s, the integrated logistics control server 30 may generate supplementary information including information of an item that the target delivery vehicle 50_m should receive from the supplementary vehicle 50_s, and may transmit it to a driver terminal 530_m of the target delivery vehicle and a driver terminal 530_s of the supplementary vehicle.

For example, it is assumed that the target delivery vehicle requires 2 A items in stock and 3 B items in stock required to process a real-time delivery order. In this case, the integrated logistics control server 30 may generate supplementary information including information related to inventory required for the target delivery vehicle. Thereafter, the integrated logistics control server 30 may transmit supplementary information to the target delivery vehicle to receive 2 A items in stock and 3 B items from the supplementary vehicle, and may transmit supplementary information to the supplementary vehicle to deliver 2 A items in stock and 3 B items to the target delivery vehicle.

In addition, the integrated logistics control server 30 may change each delivery path such that the determined target delivery vehicle 50_m and the supplementary vehicle 50_s meet at an intermediate point. The intermediate point is a place located between a delivery path of the target delivery vehicle 50_m and a delivery path of the supplementary vehicle 50_s, and may be located within a predetermined distance from a basic path of the target delivery vehicle 50_m and the supplementary vehicle 50_s. At the intermediate point, the target delivery vehicle 50_m may receive insufficient inventory from the supplementary vehicle 50_s. The integrated logistics control server 30 may change the estimated arrival time in consideration of a time it takes for the target delivery vehicle 50_m to receive the insufficient inventory from the supplementary vehicle 50_s.

When the integrated logistics control server 30 cannot determine an appropriate supplementary vehicle, the integrated logistics control server 30 may change the delivery path such that the target delivery vehicle 50_m passes through the item loading dock. However, even in this case, all transaction information previously allocated to the target delivery vehicle 50_m must be satisfied.

The integrated logistics control server 30 may transmit a delivery failure notification to the user terminal 10 when delivery is not possible within a predetermined time. When delivery is not possible, for example, delivery may not be possible until a reservation time and/or in the case of a real-time delivery order, delivery may be impossible within a predetermined time.

The integrated logistics control server 30 may transmit a set optimal delivery path to the driver terminal 530_m of a driver of the assigned target delivery vehicle 50_m. That is, the integrated logistics control server 30 may transmit the basic path and a changed path to the driver terminal 530_m through a network, and the driver terminal 530_m may display information related to the received path.

The integrated logistics control server 30 may receive the delivery status information from each of the driver terminals 530_1 to 530_n, and may check whether each of the delivery vehicles 50_1 to 50_n is operating depending on a scheduled time according to a delivery path that is set for each of the delivery vehicles 50_1 to 50_n. The integrated logistics control server 30 may display a current position of the vehicle terminal 510_i to which order information regarding the ordered item is allocated and a movement path of the vehicle terminal 510_i on an electronic map, and may provide it to the user terminal 10. The integrated logistics control server 30 may store data on the electronic map, or may download data on the electronic map from the Internet through a network.

In the present specification, it has been described that the integrated logistics control server 30 allocates order information to each of the delivery vehicles 50_1 to 50n, and then sets the optimal delivery path for each of the delivery vehicles 50_1 to 50_n, but it is not limited thereto. For example, the integrated logistics control server 30 may set an optimal delivery path for each of the delivery vehicles 50_1 to 50_n while allocating order information to each of the delivery vehicles 50_1 to 50n. In addition, the integrated logistics control server 30 may allocate one of the delivery vehicles 50_1 to 50_n for each delivery path after setting an optimal delivery path based on the order information.

FIG. 2 illustrates an example schematically showing inventory information update of the integrated logistics control server 30 according to an example.

As illustrated therein, there may be a target delivery vehicle 50_m to which first order information and second order information are assigned. The integrated logistics control server 30 may derive an optimal basic path via a first delivery destination in the first order information and a second delivery destination in the second order information, and may transmit it to the driver terminal 530_m of a driver who operates the target delivery vehicle 50_m.

The integrated logistics control server 30 may have previously acquired inventory information of the target delivery vehicle 50_m from the driver terminal 530_m, or may acquire inventory information from the driver terminal 530_m after transmitting the basic path to the driver terminal 530_m. For example, it is assumed that 50 A items and 30 B items are loaded in the target delivery vehicle.

The integrated logistics control server 30 may acquire information related to order items and a number of the order items in the first order information. As illustrated in FIG. 2, the first order information includes information that 3 A items and 2 B items are ordered.

When the target delivery vehicle 50_m is positioned in a position that faces a second delivery destination from a first delivery destination through the first delivery destination, the integrated logistics control server 30 may determine that the target delivery vehicle 50_m has processed the first order information. In this case, the integrated logistics control server 30 may subtract an inventory number of items corresponding to the first order information from the inventory information of the target delivery vehicle 50_m.

Alternatively, when receiving delivery status information including information that delivery of the first order information has been completed through the driver terminal 530_m of the target delivery vehicle 50_m, the integrated logistics control server 30 may update the inventory information of the target delivery vehicle 50_m.

When the first order information is processed, the integrated logistics control server 30 may update the inventory information of the target delivery vehicle 50_m to 47 A items and 28 B items.

Thereafter, the integrated logistics control server 30 may acquire information related to order items and a number of the order items in the second order information. As illustrated in FIG. 2, the second order information includes information that 10 A items and 20 B items are ordered.

When the target delivery vehicle 50_m is positioned on a path to face a next delivery destination after passing through the second delivery destination, the integrated logistics control server 30 may determine that the target delivery vehicle 50_m has processed the second order information. Similarly, as described above, the integrated logistics control server 30 may update the inventory information of the target delivery vehicle 50_m by subtracting an inventory number of order items corresponding to the second order information from the inventory information (47 A items and 28 B items) of the target delivery vehicle 50_m.

Alternatively, even when receiving delivery status information including information that delivery of the second order information has been completed from the driver terminal 530_m of the target delivery vehicle 50_m, the integrated logistics control server 30 may update the inventory information of the target delivery vehicle 50_m.

When the second order information is processed, the integrated logistics control server 30 may update the inventory information of the target delivery vehicle 50_m to 37 A items and 8 B items.

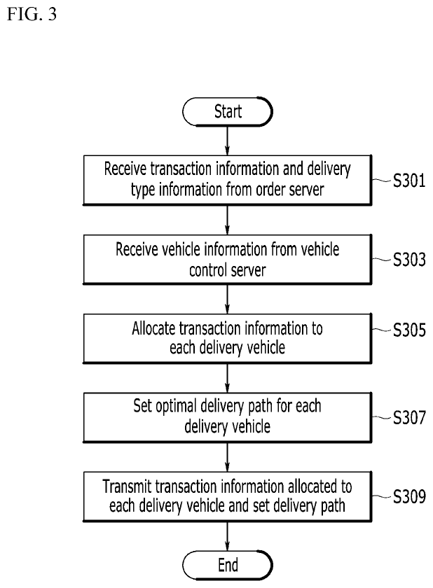

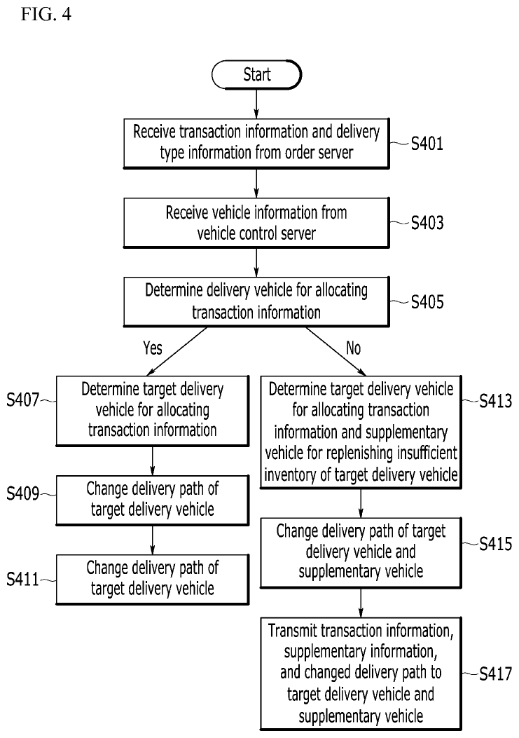

FIG. 3 and FIG. 4 each illustrate a flowchart showing a method performed by the integrated logistics control server 30 when a user places a reservation order or a real-time delivery order through the user terminal 10.

FIG. 3 illustrates a flowchart showing a method of pre-order delivery according to an embodiment.

The integrated logistics control server 30 receives transaction information and delivery type information from the order server 20 (S301).

The transaction information may include order information and user information. Herein, order information and user information may be information inputted from a user to the order server 20 through the user terminal 10. The order information may include information related to a type of the item to be ordered, a quantity of the item, a delivery address, and an order time at which the order is received. The user information may include information related to a user name and user contact information.

The delivery type information may be information related to a type of delivery selected by the user in the order server 20 through the user terminal 10. The delivery type information may include information related to real-time delivery or reservation delivery. In the case of the reservation delivery, information related to a delivery reservation time may be included. In FIG. 3, a case in which the delivery type information is reservation delivery will be described.

The integrated logistics control server 30 receives vehicle information from the vehicle control server 40 (S303).

The vehicle information may include information related to the vehicle terminals 510_1 to 510_n provided in the delivery vehicles 50_1 to 50_n; information for the plurality of delivery vehicles 50_1 to 50_n received from the plurality of vehicle terminals 510_1 to 510_n; information related to a plurality of drivers assigned to the delivery vehicles 50_1 to 50_n; information related to the driver terminals 530_1 to 530_n of the drivers; and information related to the vehicle terminals 510_1 to 510_n and the corresponding driver terminals 530_1 to 530_n.

Step S301 and step S303 may be performed simultaneously, or step S301 may be performed after step S303 is performed.

The vehicle information may be information related to a number of items that can be accommodated by each of the delivery vehicles 50_1 to 50_n, a volume of the items, a total weight of the items, a remaining battery capacity of the vehicle, and the like.

In this case, the integrated logistics control server 30 may receive inventory information related to items loaded in the delivery vehicles 50_1 to 50_n through the driver terminals 530_1 to 530_n.

The integrated logistics control server 30 allocates transaction information to each of the delivery vehicles 50_1 to 50_n (S305).

When the delivery type information received by the integrated logistics control server 30 is a reservation delivery, the integrated logistics control server 30 may allocate transaction information to each of the delivery vehicles 50_1 to 50_n in consideration of position information of each of the delivery vehicles 50_1 to 50_n and positions of delivery destinations.

In this case, the integrated logistics control server 30 may consider vehicle information such as a remaining battery capacity, a current position, and a path of each of the delivery vehicles 50_1 to 50_n. In addition, the integrated logistics control server 30 may consider a driver working state such as a driver resting state and an order allocable state, and may also consider current traffic situation and inventory information.

Thereafter, the integrated logistics control server 30 sets an optimal delivery path for each of the delivery vehicles 50_1 to 50_n (S307).

The integrated logistics control server 30 may set an optimal delivery path for each of the delivery vehicles 50_1 to 50_n based on delivery address information included in the order information received in step S301. In this case, the optimal delivery route may be set as a path having a shortest movement path or a path having a shortest movement time among multiple paths that can move from a current position of each of the delivery vehicles 50_1 to 50_n to an assigned delivery destination.

In this case, the integrated logistics control server 30 may consider the position information received from the vehicle terminals 510_1 to 510_n, and information related to the current traffic condition and/or road information received from a traffic information providing server. Traffic situation information may include traffic congestion information, vehicle accident information, and the like. The road information may include lane information, speed limit information, and the like of a road in each area.

The integrated logistics control server 30 may transmit transaction information assigned to each of the delivery vehicles 50_1 to 50_n and a set delivery path (S309).

The integrated logistics control server 30 may transmit the transaction information allocated in step S305 for the delivery vehicles 50_1 to 50_n and the optimal delivery path set in step S307 to the driver terminals 530_1 to 530_n of drivers of the delivery vehicles 50_1 to 50_n.

FIG. 4 illustrates a flowchart showing a delivery method of a real-time delivery order according to an embodiment.

The integrated logistics control server 30 receives transaction information and delivery type information from the order server 20 (S401).

Step S401 may be performed similarly to step S301 described above. However, in FIG. 4, a case in which the delivery type information is real-time delivery will be described.

The integrated logistics control server 30 receives vehicle information from the vehicle control server 40 (S403). Step S403 may be performed similarly to step S303 described above.

The integrated logistics control server 30 determines whether there is a delivery vehicle satisfying the transaction information (S405).

First, the integrated logistics control server 30 may derive a delivery vehicle that can complete delivery within a predetermined time. For example, the integrated logistics control server 30 may derive a plurality of delivery vehicles (50_h, 50_g, 50_f, . . . , wherein each is one of the natural numbers from 1 to n) positioned within a predetermined range from the delivery destination from among the delivery vehicles 50_1 to 50_n.

Thereafter, the integrated logistics control server 30 may sequentially check whether inventory information of the delivery vehicles 50_h, 50_g, 50_f, . . . may satisfy the order information in the real-time delivery order.

When there is a delivery vehicle satisfying the transaction information among the delivery vehicles 50_h, 50_g, 50_f, . . . , the integrated logistics control server 30 performs step S407, while when there is no delivery vehicle satisfying the transaction information among the delivery vehicles 50_h, 50_g, 50_f, . . . , the integrated logistics control server 30 performs step S413.

The integrated logistics control server 30 determines a target delivery vehicle for allocating transaction information (S407).

The integrated logistics control server 30 may determine the target delivery vehicle 50_m to which order information of the real-time delivery order is to be allocated based on the current position of each of the delivery vehicles 50_1 to 50_n, traffic conditions, an order time, and a basic path.

Specifically, the integrated logistics control server 30 may calculate a time it takes to complete the deliveries corresponding to the order information assigned to each of the delivery vehicles 50_1 to 50_n, so as to predict a time at which delivery of each of the delivery vehicles 50_1 to 50_n is completed. Then, the integrated logistics control server 30 may calculate a distance from a last delivery address corresponding to last order information among the order information allocated to each of the delivery vehicles 50_1 to 50_n to a real-time delivery address of a received real-time delivery order, and may predict a time when real-time delivery is completed. In this case, the integrated logistics control server 30 determines whether the time at which the real-time delivery is completed is within a predetermined time from the time the real-time delivery order is received, and when it is within the predetermined time, determines the delivery vehicle with the shortest movement distance as the target delivery vehicle 50_m.

Thereafter, the integrated logistics control server 30 changes a delivery path of the target delivery vehicle (S409).

The integrated logistics control server 30 may change the delivery path of the target delivery vehicle 50_m to pass through the delivery destination in the order information of the real-time delivery order.

The integrated logistics control server 30 transmits the transaction information and the changed delivery path to the target delivery vehicle (S411).

The integrated logistics control server 30 may transmit the transaction information assigned in step S407 and the optimal delivery path set in step S409 for the target delivery vehicle 50_m to the driver terminal 530_m of the driver of the target delivery vehicle 50_m.

The integrated logistics control server 30 determines a target delivery vehicle for allocating transaction information and a supplementary vehicle for replenishing insufficient inventory of the target delivery vehicle (S413).

When there is no delivery vehicle satisfying the transaction information among the delivery vehicles 50_h, 50_g, 50f, . . . , the integrated logistics control server 30 may determine the target delivery vehicle 50_m and a supplementary vehicle 50s, (s is one of natural numbers from 1 to n) for replenishing inventory of the target delivery vehicle 50_m among the delivery vehicles 50_h, 50_g, 50_f, . . . .

The supplementary vehicle is a vehicle that has inventory included in the order information in the real-time delivery order.

In this case, after determining the target delivery vehicle 50_m and the supplementary vehicle 50_s, the integrated logistics control server 30 may generate supplementary information including information of an item that the target delivery vehicle 50_m should receive from the supplementary vehicle 50_s, and may transmit it to a driver terminal 530_m of the target delivery vehicle and a driver terminal 530_s of the supplementary vehicle.

The integrated logistics control server 30 changes the delivery path of the target delivery vehicle and the supplementary vehicle (S415).

In addition, the integrated logistics control server 30 may change each delivery path such that the determined target delivery vehicle 50_m and the supplementary vehicle 50_s meet at an intermediate point. The intermediate point is a place located between a delivery path of the target delivery vehicle 50_m and a delivery path of the supplementary vehicle 50_s, and may be located within a predetermined distance from a base path of the target delivery vehicle 50_m and the supplementary vehicle 50_s.

The integrated logistics control server 30 transmits transaction information, supplementary information, and the changed delivery path to the target delivery vehicle and the supplementary vehicle (S417).

The integrated logistics control server 30 may transmit the transaction information assigned in step S413 and the delivery route changed in step S415 for the target delivery vehicle 50_m and the supplementary vehicle 50_s to the driver terminal 530_m of the delivery vehicle 50_m and the driver terminal 530_s of the supplementary vehicle 50_s.

The delivery management system according to embodiments of the present disclosure has an advantage that efficient delivery is possible because the optimal delivery path from a current position of each of the delivery vehicles to a delivery destination may be set in real time.

The delivery management system according to embodiments of the present disclosure has an advantage that fast delivery may be performed without significantly impacting an overall delivery time by determining a delivery vehicle to perform delivery in consideration of a distance to the delivery destination when receiving a real-time delivery order.

The delivery management system according to embodiments of the present disclosure has an advantage that efficient delivery is possible because inefficient items can be refilled even when multiple delivery vehicles do not pass through an item loading dock.

The embodiments according to the embodiments described above may be implemented in the form of a computer program that can be executed through various components on a computer, and such a computer program may be recorded in a computer-readable medium. In this case, the medium may include a hardware device specially configured to store and execute program instructions, including a magnetic medium such as a hard disk, a floppy disk, and a magnetic tape, an optical recording medium such as a CD-ROM and a DVD, a magneto-optical medium such as a floptical disk, and a ROM, a RAM, a flash memory, etc.

The steps constituting the method according to the embodiments may be performed in an appropriate order unless explicitly stated or contradicted by the order. The present invention is not necessarily limited to the described order of the steps. In the present invention, use of all examples or illustrative terms (e.g., etc.) is merely for describing the present invention in detail, and thus the scope of the present invention is not limited thereto. In addition, a person of ordinary skill in the art can recognize that various modifications, combinations, and changes may be made within the scope of the claims or their equivalents.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A delivery management method comprising:
receiving, by an integrated logistics control server, a plurality of pieces of transaction information that includes a delivery address and delivery type information corresponding to each of the plurality of pieces of transaction information from an order server;
receiving, by the integrated logistics control server, a current position of a corresponding delivery vehicle from a vehicle terminal mounted on the corresponding delivery vehicle, wherein each of a plurality of delivery vehicles including the corresponding delivery vehicle includes a respective vehicle terminal mounted thereon;
allocating, by the integrated logistics control server, transaction information having an adjacent delivery address to each of the plurality of delivery vehicles;
setting, by the integrated logistics control server, a basic path passing through delivery destinations in the transaction information allocated to each of the vehicle terminals for each of the plurality of delivery vehicles; and
changing, by the integrated logistics control server, the basic path of a target delivery vehicle of the plurality of delivery vehicles to pass through one of the delivery destinations included in the transaction information.

2. The delivery management method of claim 1, wherein changing the basic path of the target delivery vehicle comprises changing the basic path of the target delivery vehicle to pass through the delivery destination included in real-time transaction information when a delivery type is a real-time delivery.

3. The delivery management method of claim 1, wherein setting the basic path for each of the plurality of delivery vehicles comprises setting, by the integrated logistics control server, the basic path as a path having a shortest movement path or a shortest movement time among a plurality of paths passing from a current position of the vehicle terminal through the delivery destinations in the allocated transaction information.

4. The delivery management method of claim 1, wherein a driver terminal of a driver driving the delivery vehicle corresponds to each of the plurality of delivery vehicles and wherein the method further comprises transmitting, by the integrated logistics control server, the basic path and the plurality of pieces of transaction information allocated to the delivery vehicle to the driver terminal.

5. The delivery management method of claim 4, further comprising:
receiving, by the integrated logistics control server, real-time transaction information related to real-time delivery from the order server when the delivery type information indicates the real-time delivery,
wherein the real-time transaction information includes information about at least one of a type of an order item, a quantity of the order item, a real-time delivery address, and an order time.

6. The delivery management method of claim 5, further comprising:
receiving, by the integrated logistics control server, inventory information of the delivery vehicle corresponding to the driver terminal,
wherein the inventory information includes information related to a type and a quantity of items loaded in the delivery vehicle.

7. The delivery management method of claim 6, further comprising:
determining, by the integrated logistics control server, a target delivery vehicle for allocating the real-time transaction information,
wherein the target delivery vehicle is one of first delivery vehicles located within a predetermined radius from a real-time delivery address among the plurality of delivery vehicles.

8. The delivery management method of claim 7, wherein determining the target delivery vehicle further includes determining whether the target delivery vehicle has inventory information that satisfies the type of the order item and the quantity of the order item of the real-time transaction information.

9. The delivery management method of claim 8, wherein the inventory information of the target delivery vehicle satisfies the real-time transaction information and wherein the method further comprises changing, by the integrated logistics control server, a delivery path such that the target delivery vehicle passes through the real-time delivery address from the basic path of the target delivery vehicle.

10. The delivery management method of claim 8, wherein the inventory information of the target delivery vehicle cannot satisfy the real-time transaction information, wherein the method further comprises determining, by the integrated logistics control server, a supplementary vehicle for replenishing insufficient inventory of the target delivery vehicle, and wherein the supplementary vehicle is at least one of the delivery vehicles and has inventory information that is integrated with the inventory information of the target delivery vehicle to satisfy the real-time transaction information.

11. The delivery management method of claim 10, further comprising:
generating, by the integrated logistics control server, supplementary information including the type and quantity of items that the target delivery vehicle should receive from the supplementary vehicle; and
transmitting, by the integrated logistics control server, the real-time transaction information and the supplementary information to the driver terminal of the target delivery vehicle and the driver terminal of the supplementary vehicle.

12. The delivery management method of claim 11, further comprising:
changing, by the integrated logistics control server, delivery paths of the target delivery vehicle and the supplementary vehicle such that the target delivery vehicle and the supplementary vehicle meet at an intermediate point between the basic path of the target delivery vehicle and the basic path of the supplementary vehicle; and
transmitting, by the integrated logistics control server, the changed delivery paths to the driver terminal of the target delivery vehicle and the driver terminal of the supplementary vehicle.

13. A non-transitory, computer-readable medium storing a program to perform the method according to claim 1.

14. A delivery management system comprising:
an order server configured to transmit a plurality of pieces of transaction information and a delivery address and delivery type information corresponding to each of the plurality of pieces of transaction information to an integrated logistics control server, wherein the integrated logistics control server is configured to:
receive current positions of a plurality of delivery vehicles from vehicle terminals mounted on the plurality of delivery vehicles, respectively;
allocate the transaction information having an adjacent delivery address to each of the plurality of delivery vehicles;
set a basic path passing through delivery destinations in the transaction information allocated to each of the vehicle terminals for each of the plurality of delivery vehicles; and
change the basic path of a target delivery vehicle of the plurality of delivery vehicles to pass through one of the delivery destinations included in the transaction information.

15. The delivery management system of claim 14, wherein the integrated logistics control server is further configured to change the basic path of the target delivery vehicle to pass through a delivery destination included in real-time transaction information when a delivery type is real-time delivery.

16. The delivery management system of claim 14, wherein the basic path is a path having a shortest movement path or a shortest movement time among a plurality of paths passing from a current position vehicle terminal through the delivery destinations in the assigned transaction information.

17. The delivery management system of claim 14, further comprising a driver terminal of a driver driving the delivery vehicle for each of the plurality of delivery vehicles, wherein the integrated logistics control server is configured to transmit the plurality of pieces of transaction information allocated to the delivery vehicle and the basic path to the driver terminal.

18. The delivery management system of claim 17, wherein:
the integrated logistics control server is configured to receive real-time transaction information related to real-time delivery from the order server when the delivery type information indicates the real-time delivery; and
the real-time transaction information includes information about at least one of a type of an order item, a quantity of the order item, a real-time delivery address, and an order time.

19. The delivery management system of claim 18, wherein:
the integrated logistics control server is configured to further receive inventory information of the delivery vehicle corresponding to the driver terminal; and
the inventory information includes information related to a type and a quantity of items loaded in the delivery vehicle.

20. The delivery management system of claim 19, wherein:
the integrated logistics control server is configured to determine a target delivery vehicle for allocating the real-time transaction information; and
the target delivery vehicle is one of first delivery vehicles located within a predetermined radius from an address of the real-time delivery among the plurality of delivery vehicles.

21. The delivery management system of claim 20, wherein the integrated logistics control server is configured to determine the target delivery vehicle by determining whether the target delivery vehicle has inventory information that satisfies the type of the order item and the quantity of the order item of the real-time transaction information.

22. The delivery management system of claim 21, wherein:
the integrated logistics control server is configured to determine the target delivery vehicle which has the inventory information that satisfies the real-time transaction information; and
the integrated logistics control server is configured to change a delivery path such that the target delivery vehicle passes through the real-time delivery address from the basic path of the target delivery vehicle.

23. The delivery management system of claim 21, wherein:
the integrated logistics control server is configured to determine the target delivery vehicle which has the inventory information that cannot satisfy the real-time transaction information;
the integrated logistics control server is configured to determine a supplementary vehicle for replenishing insufficient inventory of the target delivery vehicle; and
the supplementary vehicle is at least one of the delivery vehicles and has inventory information that is integrated with the inventory information of the target delivery vehicle to satisfy the real-time transaction information.

24. The delivery management system of claim 23, wherein the integrated logistics control server is configured to:
generate supplementary information including the type and quantity of items that the target delivery vehicle should receive from the supplementary vehicle; and
transmit the real-time transaction information and the supplementary information to the driver terminal of the target delivery vehicle and the driver terminal of the supplementary vehicle.

25. The delivery management system of claim 24, wherein the integrated logistics control server is configured to:
change delivery paths of the target delivery vehicle and the supplementary vehicle such that the target delivery vehicle and the supplementary vehicle meet at an intermediate point between basic paths of the target delivery vehicle and the supplementary vehicle; and
transmit the changed delivery paths to the driver terminal of the target delivery vehicle and the driver terminal of the supplementary vehicle.

26. An integrated logistics control server comprising:
an order server configured to receive a plurality of pieces of transaction information and a delivery address and delivery type information corresponding to each of the plurality of pieces of transaction information from a user terminal; and
a vehicle control server configured to assign a respective driver to each of a plurality of delivery vehicles,
wherein the integrated logistics control server is configured to:
receive current positions of the plurality of delivery vehicles from vehicle terminals mounted on the plurality of delivery vehicles, respectively;
allocate transaction information having an adjacent delivery address to each of the plurality of delivery vehicles;
set a basic path passing through delivery destinations in the transaction information allocated to each of the vehicle terminals for each of the plurality of delivery vehicles; and
change a basic path of a target delivery vehicle of the plurality of delivery vehicles to pass through the delivery destination included in real-time transaction information when a delivery type is real-time delivery.

27. An integrated logistics control server comprising:
a vehicle control server configured to assign a respective driver to each of a plurality of delivery vehicles,
wherein the integrated logistics control server is configured to:
receive a plurality of pieces of transaction information and a delivery address and delivery type information corresponding to each of the plurality of pieces of transaction information from a user terminal;
receive current positions of the plurality of delivery vehicles from vehicle terminals mounted on the plurality of delivery vehicles, respectively;
allocate transaction information having an adjacent delivery address to each of the plurality of delivery vehicles;
set a basic path passing through delivery destinations in the transaction information allocated to each of the vehicle terminals for each of the plurality of delivery vehicles; and
change a basic path of a target delivery vehicle of the plurality of delivery vehicles to pass through the delivery destination included in real-time transaction information when a delivery type is real-time delivery.

28. A delivery management system comprising:
an order server configured to transmit a plurality of pieces of transaction information and a delivery address and delivery type information corresponding to each of the plurality of pieces of transaction information to an integrated logistics control server, wherein the integrated logistics control server is configured to:
receive current positions of a plurality of delivery vehicles from vehicle terminals mounted on the plurality of delivery vehicles;
allocate transaction information having an adjacent delivery address to each of the plurality of delivery vehicles;
set a basic path passing through delivery destinations in the transaction information allocated to each of the vehicle terminals for each of the plurality of delivery vehicles;
determine a target delivery vehicle for allocating real-time transaction information when a delivery type is real-time delivery; and
change the basic path of the target delivery vehicle to pass through the delivery destination included in the real-time transaction information,
wherein the target delivery vehicle is a delivery vehicle having a shortest movement distance from a last delivery destination to a real-time delivery destination among the delivery vehicles when a completion time for a delivery corresponding to the real-time transaction information is within a predetermined time from an acceptance time for the real-time delivery wherein the integrated logistics control server is configured to:
calculate a completion time for a delivery corresponding to transaction information assigned to each of the vehicle terminals by calculating a time it takes to travel to the last delivery destination among basic paths that are set for each of the vehicle terminals; and
calculate the completion time for the delivery corresponding to the real-time transaction information by calculating the distance from the last delivery destination to the real-time delivery destination in the real-time transaction information for each of the plurality of delivery vehicles.
